(19) United States
(12) Patent Application Publication
(10) Pub. No.: US 2006/0137551 A1
(43) Pub. Date: Jun. 29, 2006

(54) Compensator sleeve for flexographic printing

(75) Inventor: Armand Piolat, Saint Georges D'Esperanche (FR)

Correspondence Address: OLIFF & BERRIDGE, PLC, P.O. BOX 19928, ALEXANDRIA, VA, 22320, US

(73) Assignee: DUCHENAUD UNIFLEXO, Bourgoin Jallieu (FR)

(21) Appl. No.: 11/019,746

(22) Filed: Dec. 23, 2004

(51) Int. Cl. B41F 13/10

(52) U.S. Cl. 101/375

(57) ABSTRACT

A composite compensator sleeve (3), designed specifically to compensate for the dimensional difference that exists between a rotational drive carrier (1) and a printing forme (2), the outer face (2b) of which forms a flexographic plate, which sleeve comprises, fastened to one another, so as to be unable to undergo any rotational and translational movement relative to the others, from the inside outward:
a tubular nickel-based metal internal base (5), providing the cylindrical inner face (3a) of said compensator sleeve, the thickness of which is between 0.1 and 0.25 mm, and is obtained by electroplating;
an external layer (6) of a hard elastomer material, providing the outer face (3b) of said compensator sleeve; and
an intermediate layer (7) of a soft elastomer material, placed between the metal internal base (5) and the hard external layer (6).

The invention relates to a flexographic printing process in which, in general:

(a) at least a rotational drive carrier that provides a cylindrical outer bearing surface, a continuous or discontinuous printing forme having a plane internal face and an external face in relief, forming the flexographic plate, and a composite compensator sleeve between, on one side, the outer bearing surface of the carrier and, on the other side, the internal face of the forme, this compensator sleeve itself having a cylindrical inner face suitable for being fitted by sliding over and then by gripping onto the outer bearing surface of the carrier, and a cylindrical outer face, the developed surface of which is suitable for supporting and fastening the cylindrically formed or deformed printing forme, via its internal face, is used;

(b) the printing forme is fastened onto the compensator sleeve;

(c) the compensator sleeve is fitted to the carrier so as to prevent any rotational movement relative to the latter;

(d) the assembly consisting of the carrier, the compensator sleeve and the forme, the plate of which is coated with an ink, is made to rotate in contact with a substrate to be printed, such as a sheet of paper, board or polyethylene, etc.

Consequently, a compensator sleeve is designed specifically to compensate for the dimensional difference that exists between a rotational drive carrier and a printing forme, the outer face of which forms a flexographic plate. A compensator sleeve should be distinguished, on the one hand, from a flexographic printing sleeve, consisting in general of a base made of metal or of a composite material, coated with a photopolymer or rubber, and, on the other hand, a transfer sleeve or blanket, generally consisting of a rubber-coated metal base.

At the present time, a compensator sleeve for flexographic printing constitutes a relatively large and relatively heavy component, which has to have various relatively opposing mechanical characteristics, with particularly precise internal and external dimensions.

On one side, that is to say on the side adjacent to its cylindrical inner face, the compensator sleeve is deformed or expanded centrifugally, but to a limited extent, over a short duration, by the effect of a pressurized gas cushion (the gas being for example compressed air between 5 and 8 bar in pressure), so as to be moved away from the carrier and then put into place on said carrier by sliding, or extracted therefrom, depending on the case. However, the sleeve must exhibit sufficient centripetal elasticity to return to the clamped position against the cylindrical outer bearing surface of the carrier once the centrifugal force has been removed. In the clamped position against the carrier, the compensator sleeve must remain, almost permanently, dimensionally stable, in particular as regards its inner cross section, so as to prevent, during printing, any relative rotational slip between the carrier and the compensator sleeve. These radial elasticity and dimensional stability characteristics must remain for as long as possible, despite a large number of times it is fitted on and removed from the carrier.

On the other side, i.e. on the side adjacent to its cylindrical outer face, the compensator sleeve must remain relatively hard, on the one hand, on account of its rotational bearing against the substrate to be printed (paper, board, plastic, etc.) during the flexographic printing process, and, on the other hand, the compensator sleeve must retain its nominal outside diameter value for controlled flexographic printing.

This hardness of the outer face also allows it to be polished, with a view to perfect adhesion of the printing forme.

Moreover, it is essential that the compensator sleeve be of almost perfect volume uniformity, in order to avoid any “imbalance” during its rotation at high speed, which would generate vibrations degrading the quality of the flexographic printing.

In practice, owing to these requirements, a compensator sleeve can only be a composite part.

As an example, a compensator sleeve currently available on the market, manufactured and/or sold by Rotec and by Polywest (in Germany), Rossini (in Italy) and by Axcyl (in France) comprises, fastened to one another, so as to be unable to undergo any rotational and translational movement relative to one another, from the inside outward:

a first tube made of a material consisting of a glass or carbon fiber woven impregnated with a resin, having a thickness of for example 1.2 mm;

an insert layer of a foam of an elastomer material of the polyurethane type, having a thickness of for example 1 mm;

a second tube made of a material consisting of a glass or carbon fiber nonwoven impregnated with a resin, having a thickness of for example 1 to 4 mm;

an intermediate layer of an elastomer material of the low-density polyurethane type; and

an external layer of an elastomer material of the high-density polyurethane type, the intermediate and outer layers together having a thickness varying between 2 and 25 mm.

In practice, the material of the first tube, in this case a glass fiber woven impregnated with a resin, does not make it possible to reconcile; over time, the centrifugal radial elasticity and the centripetal gripping stability.

Several reasons explain this observation:

The aforementioned material progressively loses its initial stresses that originally allowed it to ensure good clamping—centrifugal relaxation therefore occurs after a certain number of mounting/printing/removal cycles.

This material and more particularly the resin that impregnates it have a glass transition temperature, i.e. the temperature for transition from the glassy state to the rubbery state, of between 60 and 150° C. Consequently, during the process of manufacturing the continuous printing forme, in the form of a sleeve, made of a photopolymer material fixed beforehand on the compensator sleeve, the forme undergoes, during curing of the photopolymer constituting the printing forme, a relatively large rise in temperature, for example between 110° C. and 140° C. for 30 minutes, exceeding this glass transition temperature, above which the dimensional stability of the material of the first tube is no longer guaranteed. Subsequently, on returning to room temperature, this material no longer has its original dimensions, therefore in particular compromising its clamping capacity.

The object of the present invention is to remedy the drawbacks identified above.

The subject of the invention, in the context of a flexographic printing process, is a compensator cylinder of particularly simple construction and exhibiting, over time, dimensional stability of both its internal and external cross sections and centripetal radial elasticity at its cylindrical inner face remaining compatible with this dimensional stability.

According to the invention, the composite compensator sleeve comprises, fastened to one another, so as to be unable to undergo any rotational and translational movement relative to the others, from the inside outward:

a tubular nickel-based metal internal base, providing the cylindrical inner face of said compensator sleeve, the thickness of which is between 0.1 and 0.25 mm, and is obtained by electroplating;

an external layer of a hard elastomer material, providing the outer face of said compensator sleeve; and

an intermediate layer of a soft elastomer material, placed between the metal internal base and the hard external layer.

The term “nickel-based” is understood to mean that the constituent nickel of the internal base, to a extent predominant, may be alloyed, to a minor extent, with one or more metals, or indeed other nonmetallic elements, provided that the combination of the nickel and/or the other metals can be deposited on any suitable substrate by electrolysis or electroplating.

Thanks to the composite structure adopted by the present invention, the relatively hard external layer of the compensator sleeve is not subjected to any large deformation, thanks to the relatively soft insert layer, notwithstanding the elastic, centrifugal radial deformations of the internal base.

The relatively hard external layer exerts a limited pressure on the internal base via the relatively soft intermediate layer during the internal base expansion phases, thus helping said base to maintain constant clamping on the carrier.

Thanks to the invention, with only the nickel-based intermediate base, and moreover of a small thickness, it is possible to reconcile, at the inner face of the compensator sleeve, the centrifugal radial elasticity and the centripetal dimensional stability. This results in particular from the fact that the nickel obtained by electroplating, with a small thickness, has a three-dimensional, face-centered cubic, crystal structure exhibiting uniformity, cohesion and elasticity.

It follows from experiments carried out by the Applicant that, outside the range between (and including) 0.1 mm and 0.25 mm, it appears impossible to reconcile elasticity and dimensional stability.

By forming the internal base by electroplating it is possible to obtain, in the metal substrate, internal stresses that allow constant clamping over time.

In addition, the perfectly smooth surface finish inside the nickel metal base significantly facilitates propagation of the air cushion needed for mounting the base on the carrier and removing it therefrom. This therefore makes it possible to limit this air stream in terms of thickness, which further reduces the expansion of the base.

Since the base is manufactured by an electroforming process, the inside diameter may be the exact reflection of the geometry of the cylindrical outer bearing surface of the carrier. The inner surface finish of the base and the thickness of the deposit are therefore almost perfect, which avoids any subsequent grinding.

Finally, nickel is a completely recyclable material, which makes it possible to recover the scrap in manufacturing the base.

The manufacture of a nickel base by electroplating requires few handling operations, and the manufacturing time is relatively short.

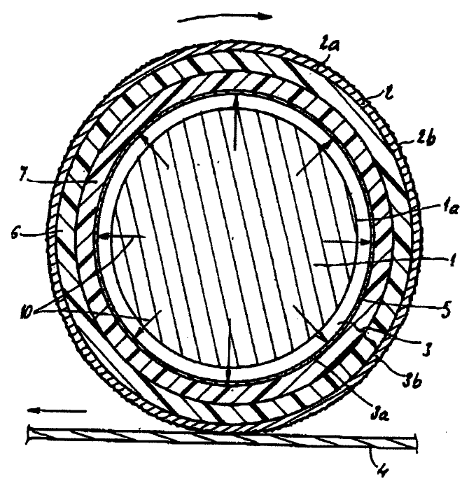

The present invention will now be described with reference to the appended drawing, in which FIG. 1 shows an exploded view, on an enlarged scale, of a carrier/compensator sleeve/printing forme assembly according to the present invention.

Any flexographic printing process may be defined, with reference to FIG. 1, in the following manner:

a) the process starts with at least one rotational drive carrier (1) that is provided with compressed-air ejection holes (10) and providing a perfectly cylindrical outer bearing surface (1a), a continuous or discontinuous printing forme (2) having a plane internal face (2a) and an external face (2b) in relief, forming the flexographic printing plate, and a composite compensator sleeve (3) between, on one side, the outer bearing surface (1a) of the carrier (1) and, on the other side, the internal face (2a) of the forme (2), this compensator sleeve itself having a cylindrical inner face (3a) suitable for being fitted by sliding over and then by gripping onto the outer bearing surface (1a) of the carrier (1), and a cylindrical outer face (3b), the developed surface of which is suitable for supporting and fastening the cylindrically formed or deformed printing forme (2), via its internal face (2a);

b) the printing forme (2) is fastened to the compensator sleeve (3), for example by adhesive bonding, or by melting the photopolymer material of which it is made;

c) the compensator sleeve is fitted onto the carrier, so as to prevent any rotational movement relative to the latter, and to do so by means of the air cushion (10); and

d) the assembly consisting of the carrier (1), the compensator sleeve (3) and the printing forme (2), the plate (2b) of which is coated with an ink, which can rotate only as one piece, is made to rotate in contact with a substrate (4) to be printed, for example a sheet of paper or polyethylene.

According to the invention, the composite compensator sleeve (3) comprises, fast to one another so as to be unable to undergo any rotational and translational movement relative to one another, from the inside outward:

a tubular nickel-based metal internal base, providing the cylindrical inner face (3a) of said compensator sleeve, the thickness of which is between 0.1 and 0.25 mm, and is obtained by electroplating or electroforming;

an external layer (6) of a hard elastomer material, for example of polyurethane type, providing the cylindrical outer face (3b) of said compensator sleeve (3); and

an intermediate layer (7) of a soft elastomer material, placed between the metal internal base (5) and the hard external layer (6).

It should be understood that other constituents or layers may be placed, respectively, between the internal base (5) and the intermediate layer (7), and between the external layer (6) and the intermediate layer (7).

Preferably, the compensator sleeve (3)-consists solely of the tubular internal base (5), the external layer (6) of the hard elastomer material and the intermediate layer (7) of the soft elastomer material, these layers being bonded together.

Preferably, the difference in Shore D hardness between the hard elastomer material and the soft elastomer material is at least 30.

The compensator cylinder described above has, for example, at least one of the following secondary features:

the intermediate layer (7) of the soft elastomer material has a thickness of at most 40 mm, preferably between 1 and 20 mm, for example, of 7 mm;

the hard elastomer material, for example of the polyurethane type, has a Shore D hardness of at least 50, preferably between 50 and 90, for example around 70, with a density of 1.15 g/cm³; and

the soft elastomer material has a hardness of at most 60 Shore A, preferably of between 60 Shore A and 50 Shore D, for example around 30 Shore D, with a density of around 0.75 g/cm³.

By way of example, the manufacture of a compensator sleeve according to the present invention will be described below:

(1) an internal nickel base (5) is obtained by electroplating, for example with a thickness of 0.15 mm;

(2) this internal base (5) is fitted onto the carrier 1, by the pneumatic means (10) described above. The assembly is then rotated, at constant speed, on a lathe;

(3) a soft polyurethane, capable of crosslinking, or undergoing crosslinking, is deposited, in one or more passes, by a casting nozzle that moves parallel to the axis of the carrier 1, during rotation of the latter. The bead of material thus created helically coats the entire outer surface of the internal base 5, having, once crosslinked, a thickness of 2 to 3 mm;

(4) once the surface has been covered, the coating head is again positioned at the starting point, ready to carry out a new pass, with a change of material, in this case with a hard polyurethane, capable of crosslinking or undergoing crosslinking, and again of doing so in one or more passes;

(5) once the coating has been carried out with the soft polyurethane and with the hard polyurethane, the compensator sleeve (3), thus manufactured, is removed from the carrier (1) by the same pneumatic means (10); and

(6) the outer surface of the compensator sleeve may, if required, be machined in order to give it the dimensions and the surface finish that are necessary for fitting the printing forme 2.

1. A flexographic printing process, in which:
(a) at least a rotational drive carrier (1) that provides a cylindrical outer bearing surface (1a), a continuous or discontinuous printing forme (2) having a plane internal face (2a) and an external face (2b) in relief, forming the plate, and a composite compensator sleeve (3) between, on one side, the outer bearing surface (1a) of the carrier (1) and, on the other side, the internal face (2a) of the forme (2), said compensator sleeve having a cylindrical inner face (3a) suitable for being fitted by sliding over and then by gripping onto the outer bearing surface (1a) of the carrier, and a cylindrical outer face (3b), the developed surface of which is suitable for supporting and fastening the cylindrically formed or deformed printing forme (2), via its internal face, is used;
(b) the printing forme (2) is fastened to the compensator sleeve (3);
(c) the compensator sleeve (3) is fitted onto the carrier so as to prevent any rotational movement relative to the latter;
(d) the assembly consisting of the carrier (1), the compensator sleeve (3) and the forme (2), the plate (2b) of which is coated with an ink, is made to rotate in contact with a substrate (4) to be printed, wherein the composite compensator sleeve (3) comprises, fastened to one another, so as to be unable to undergo any rotational and translational movement relative to one another, from the inside outward:
a tubular nickel-based metal internal base (5), providing the cylindrical inner face (3a) of said compensator sleeve, the thickness of which is between 0.1 and 0.25 mm, and is obtained by electroplating;
an external layer (6) of a hard elastomer material, providing the outer face (3b) of said compensator sleeve (3); and
an intermediate layer (7) of a soft elastomer material, placed between the metal internal base (5) and the hard external layer (6).

2. The process as claimed in claim 1, wherein the compensator sleeve (3) consists of the tubular internal base (5), the external layer (6) of the hard elastomer material and the intermediate layer (7) of the soft elastomer material, these layers being bonded together.

3. The process as claimed in claim 1, wherein the intermediate layer (7) of the soft elastomer material has a thickness of at most 40 mm, preferably between 1 and 20 mm, for example of 7 mm.

4. The process as claimed in claim 1, wherein the hard elastomer material has a Shore D hardness of at least 50, preferably between 50 and 90, for example around 70, with a density of 1.15 g/cm³.

5. The process as claimed in claim 1, wherein the soft elastomer material has a hardness of at most 60 Shore A, preferably of between 60 Shore A and 50 Shore D, for example around 30 Shore D, with a density of 0.75 g/cm³.

6. The process as claimed in claim 1, wherein the difference in Shore D hardness between the hard elastomer material and the soft elastomer material is at least 30.

7. A composite compensator sleeve (3), designed specifically to compensate for the dimensional difference that exists between a rotational drive carrier (1) and a printing forme (2), the outer face (2b) of which forms a flexographic plate, which sleeve comprises, fastened to one another, so as to be unable to undergo any rotational and translational movement relative to one another, from the inside outward:
a tubular nickel-based metal internal base, providing the cylindrical inner face of said compensator sleeve, the thickness of which is between 0.1 and 0.25 mm, and is obtained by electroplating;
an external layer of a hard elastomer material, providing the outer face of the cylindrical cylinder of said compensator sleeve; and
an intermediate layer of a soft elastomer material, placed between the metal internal base and the hard external layer.
